(19) United States
(12) Patent Application Publication
(10) Pub. No.: US 2026/0237088 A1
(43) Pub. Date: Aug. 13, 2026

(54) SYSTEMS AND METHODS FOR AUTOMATICALLY DETERMINING BALLAST EXCESSES AND SHORTAGES

(71) Applicant: BNSF Railway Company, Fort Worth, TX (US)

(72) Inventors: Michael S. Saniei, Fort Worth, TX (US); Ranjan Dash, Flower Mound, TX (US); Yasha Hajizeinalibiouki, Plano, TX (US)

(73) Assignee: BNSF Railway Company, Fort Worth, TX (US)

(21) Appl. No.: 19/051,629

(22) Filed: Feb. 12, 2025

Related U.S. Application Data
(63) Continuation-in-part of application No. 19/051,517, filed on Feb. 12, 2025.

(51) Int. Cl. G06T 7/62; B61L 23/04; G06T 7/11; G06T 17/20

(52) U.S. Cl. CPC G06T 7/62; B61L 23/041; B61L 23/048; G06T 7/11; G06T 17/20; G06T 2207/10028; G06T 2207/30252; G06T 2210/56

(57) ABSTRACT

A method for determining railroad ballast volumes using light detection and ranging (LiDAR) includes accessing LiDAR point cloud data captured using a LiDAR instrument and segmenting a railroad track into a plurality of railroad track segments. The LiDAR point cloud data includes locations of objects and surfaces within a railroad track environment. The method further includes accessing a plurality of ballast profiles for a particular railroad track segment, generating a ballast surface mesh from the plurality of ballast profiles, and determining a portion of the LiDAR point cloud data corresponding to the particular railroad track segment. The method further includes comparing the ballast surface mesh to the determined portion of the LiDAR point cloud data corresponding to the particular railroad track segment, determining, based on the comparison, a ballast volume for the particular railroad track segment, and displaying the ballast volume for the particular railroad track segment on an electronic display.

### CROSS-REFERENCE TO RELATED APPLICATIONS

The present application is a continuation-in-part of pending and co-owned U.S. patent application Ser. No. 19/051,517, entitled “SYSTEMS AND METHODS FOR IDENTIFYING RAILROAD TRACK RAILS AND DETERMINING RAILROAD TRACK CHARACTERISTICS USING LIDAR, filed Feb. 12, 2025, the entirety of which is herein incorporated by reference for all purposes.

### TECHNICAL FIELD

The present disclosure relates generally to railroad track ballast, and more particularly to systems and methods for automatically determining ballast excesses and shortages.

### BACKGROUND

Railroad transportation systems traverse entire continents to enable the transport and delivery of passengers and goods throughout the world. To enable the efficient and safe operation of railroad transportation systems, a railroad operator utilizes many different hardware and software systems. These systems often rely on accurate data about the railroad system in order to function properly. For example, systems that provide clearance for oversized loads being transported by a train may require accurate and precise data regarding the physical locations of rails of railroad tracks and physical characteristics of the railroad tracks such as track curvature. As another example, systems that analyze ballast and ties of a railroad track may require accurate and precise data regarding the physical locations of rails of railroad tracks and physical characteristics of the railroad tracks such as the track cross-level.

Typically, railroad track data such as the physical locations of the rails of railroad tracks and physical characteristics of the railroad tracks such as track curvature and track cross-level may be outdated and imprecise. This may cause software and hardware systems utilized by railroad operators to maintain and operate railroad transportation systems to be inefficient or inaccurate. Furthermore, typical methods of determining the physical locations of the rails of railroad tracks and physical characteristics of the railroad tracks such as track curvature and track cross-level are labor-intensive and may involve manual measurements and guesswork. This may ultimately result in imprecise data and may ultimately cause systems that rely on such data to fail, thereby decreasing the overall efficiency of railroad operations.

### SUMMARY

The present disclosure achieves technical advantages as systems, methods, and computer-readable storage media for automatically determining ballast excesses and shortages for transportation systems such as railroads. The functionality for determining ballast excesses and shortages is based on a comparison between LiDAR (Light Detection and Ranging) point cloud data and ballast profiles for individual segments of railroad track. The ballast profiles may be generated based on railroad track geometry, and the railroad track is segmented based on obstructions such as bridges, crossings, and signals. The LiDAR point cloud data is captured by one or more LiDAR instruments that are attached to a rail vehicle as the rail vehicle traverses the railroad track.

In embodiments, the present disclosure provides for a system integrated into a practical application with meaningful limitations as systems, methods, and computer-readable storage media for automatically determining ballast excesses and shortages for transportation systems such as railroads. In embodiments, a ballast excess and shortage tracking system may be configured to capture LiDAR point cloud data using one or more LiDAR instruments. The ballast excess and shortage tracking system may be further configured to segment a railroad track into a plurality of railroad track segments, generate a ballast surface mesh from a plurality of ballast profiles for each particular railroad track segment, and determine a ballast volume for each particular railroad track segment.

A technical improvement of the features provided herein includes automatically determining ballast excesses and shortages for transportation systems such as railroads. This ballast volume determination process contributes to the overall efficiency of the railroad operations by streamlining ballast maintenance operations. In addition, the system of embodiments can generate alerts and notifications to personnel in order to view ballast volumes for a particular segment of railroad track.

Collectively, these technical improvements provided by embodiments of the present disclosure contribute to a more safe, efficient, and reliable railroad operation, capable of handling the complexities of modern freight transportation.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for determining ballast excesses and shortages. In doing so, the present disclosure goes well beyond a mere application the manual process to a computer. Accordingly, the disclosure and/or claims herein necessarily provide a technological solution that overcomes a technological problem.

Furthermore, the functionality for automatically determining ballast excesses and shortages provided by the present disclosure represents a specific and particular implementation that results in an improvement in the utilization of a computing system for resource optimization. Thus, rather than a mere improvement that comes about from using a computing system, the present disclosure, in enabling a system to leverage functionality for determining ballast excesses and shortages to optimize ballast maintenance operations, represents features that result in a computing system device that can be used more efficiently and is improved over current systems that do not implement the functionality described herein. As such, the present disclosure and/or claims are directed to patent eligible subject matter.

In embodiments, the present disclosure includes techniques for training models (e.g., machine-learning models, artificial intelligence models, algorithmic constructs, etc.) for performing or executing a designated task or a series of tasks (e.g., one or more features for automatically determining ballast excesses and shortages in accordance with embodiments of the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical applications that significantly enhance the functionality, reliability, and efficiency of the models developed through these processes.

In embodiments, the present disclosure includes techniques for generating a notification of an event (e.g., a calculation of a ballast volume, etc.) includes generating an alert that includes information specifying the location of a source of data associated with the event, formatting the alert into data structured according to an information format; and transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of automatically determining ballast excesses and shortages. It is a further object of the disclosure to provide a system for automatically determining ballast excesses and shortages, and a computer-based tool for automatically determining ballast excesses and shortages. These and other objects are provided by the present disclosure, including at least the following embodiments.

In one particular embodiment, a system for determining railroad ballast volumes using LiDAR is provided. The system includes one or more LiDAR instruments configured to capture LiDAR point cloud data that indicates locations of objects and surfaces within a railroad track environment. The system further includes one or more memory units configured to store the LiDAR point cloud data and a plurality of ballast profiles. The system further includes one or more computer processors communicatively coupled to the one or more memory units and configured to access the LiDAR point cloud data. The one or more computer processors are further configured to segment a railroad track into a plurality of railroad track segments. The one or more computer processors are further configured to access, from the plurality of ballast profiles stored in the one or more memory units, a plurality of ballast profiles for the particular railroad track segment. Each ballast profile indicates a desired amount of ballast around the particular railroad track segment at a particular point along particular railroad track segment. The one or more computer processors are further configured to generate a ballast surface mesh from the plurality of ballast profiles for the particular railroad track segment and to determine a portion of the LiDAR point cloud data corresponding to the particular railroad track segment. The one or more computer processors are further configured to compare the ballast surface mesh to the determined portion of the LiDAR point cloud data corresponding to the particular railroad track segment. The one or more computer processors are further configured to determine, based on the comparison, a ballast volume for the particular railroad track segment. The one or more computer processors are further configured to display the ballast volume for the particular railroad track segment on an electronic display.

In another embodiment, a method of determining railroad ballast volumes using LiDAR is provided. The method includes accessing LiDAR point cloud data captured using one or more LiDAR instruments. The LiDAR point cloud data includes locations of objects and surfaces within a railroad track environment. The method further includes segmenting a railroad track into a plurality of railroad track segments. The method further includes accessing a plurality of ballast profiles for the particular railroad track segment. Each ballast profile indicates a desired amount of ballast around the particular railroad track segment at a particular point along particular railroad track segment. The method further includes determining a portion of the LiDAR point cloud data corresponding to the particular railroad track segment and comparing the ballast surface mesh to the determined portion of the LiDAR point cloud data corresponding to the particular railroad track segment. The method further includes determining, based on the comparison, a ballast volume for the particular railroad track segment and displaying the ballast volume for the particular railroad track segment on an electronic display.

In yet another embodiment, one or more computer-readable non-transitory storage media embodying instructions is provided. When executed by a processor, the instructions cause the processor to perform operations including accessing LiDAR point cloud data captured using one or more LiDAR instruments. The LiDAR point cloud data includes locations of objects and surfaces within a railroad track environment. The operations further include segmenting a railroad track into a plurality of railroad track segments. The operations further include accessing a plurality of ballast profiles for the particular railroad track segment. Each ballast profile indicates a desired amount of ballast around the particular railroad track segment at a particular point along particular railroad track segment. The operations further include determining a portion of the LiDAR point cloud data corresponding to the particular railroad track segment and comparing the ballast surface mesh to the determined portion of the LiDAR point cloud data corresponding to the particular railroad track segment. The operations further include determining, based on the comparison, a ballast volume for the particular railroad track segment and displaying the ballast volume for the particular railroad track segment on an electronic display.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a ballast excess and shortage tracking system, according to particular embodiments.

FIG. 2A illustrates a cross-sectional view of a railroad track and a ballast profile, according to particular embodiments.

FIG. 2B illustrates ballast excesses and shortages that have been identified by the ballast excess and shortage tracking system of FIG. 1, according to particular embodiments.

FIGS. 4A-4C illustrate various railroad track obstructions, according to particular embodiments.

FIG. 5 illustrates a ballast profile surface mesh generated by the ballast excess and shortage tracking system of FIG. 1, according to particular embodiments.

FIG. 6 illustrates a LiDAR point cloud data segment, according to particular embodiments.

FIG. 7 illustrates an overlay that displays a ballast profile surface mesh superimposed over a LiDAR point cloud data segment for a particular railroad track segment, according to particular embodiments.

FIG. 8 illustrates the calculation of a ballast volume using a ballast profile surface mesh, according to particular embodiments.

FIG. 9 illustrates a ballast profile report that may be generated by the ballast excess and shortage tracking system of FIG. 1, according to particular embodiments.

FIG. 10 is a chart illustrating a method for determining railroad ballast volumes using LiDAR, according to particular embodiments.

FIG. 11 is an example computer system that can be utilized to implement aspects of the various technologies presented herein, according to particular embodiments.

FIG. 12 illustrates a ballast profile generation module that may be utilized by the ballast excess and shortage tracking system of FIG. 1, according to particular embodiments.

FIG. 13A illustrates rails and a track centerline that have been identified by the rail identification module of FIG. 12, according to particular embodiments.

FIG. 13B illustrates a top-of-rails position that has been identified by the rail identification module of FIG. 12, according to particular embodiments.

FIG. 14 illustrates the calculation of a curvature of a railroad track by the rail identification module of FIG. 12, according to particular embodiments.

FIG. 15A illustrates the calculation of a cross-level of a railroad track by the rail identification module of FIG. 3, according to particular embodiments.

FIG. 15B illustrates the generation of a ballast profile by the ballast profile generation module of FIG. 12, according to particular embodiments.

FIG. 16 illustrates various adjacent ballast profiles that may be generated by the ballast profile generation module of FIG. 12, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive, may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

In railroad transportation systems, railroad track is typically supported by crushed rock known as ballast. The ballast is packed below and around the railroad ties of the railroad track and serves as a bed to bear the compression loads of the railroad track. Maintaining proper levels of ballast is important for maintaining the integrity and safety of railroad track. Too little ballast (e.g., due to erosion from weather) can negatively impact the integrity of the railroad track, thereby increasing the risk of derailment.

Typical methods of determining existing ballast levels for railroad tracks are labor-intensive and may involve manual measurements and/or guesswork. For example, railroad maintenance planners may simply assign a predetermined amount of replacement ballast for a railroad track without knowing the actual amount of ballast needed for the railroad track. This may ultimately result in an improper amount of ballast being ordered, delivered, or applied to the railroad track. For example, typical methods of determining existing ballast levels for railroad tracks may result in a deficient amount of ballast being applied by a maintenance crew to a railroad track, thereby degrading the safety of the railroad track. As another example, typical methods of determining existing ballast levels for railroad tracks may result in an excess amount of ballast being applied to a railroad track, thereby increasing the costs of operations of the railroad track and decreasing the overall efficiency of railroad operations.

To address these and other problems with manually determining ballast volumes for railroad tracks, embodiments of the disclosure provide systems and methods that automatically determine ballast excesses and shortages for transportation systems such as railroads. In general, the disclosed embodiments determine ballast excesses and shortages of a railroad track based on a comparison between LiDAR point cloud data and ballast profiles for individual segments of railroad track. For example, certain embodiments may first segment a railroad track into a plurality of railroad track segments. The segmentation of the railroad track into the plurality of railroad track segments may be based on, for example, railroad track obstructions such as bridges, crossings, and signals. Each railroad track segment may be a predetermined length of railroad track such as between 200-300 feet. After the railroad track has been segmented into railroad track segments, the disclosed embodiments may compare LiDAR point cloud data for each particular railroad track segment to a ballast profile mesh for the particular railroad track segment in order to determine a ballast volume for the particular railroad track segment. The ballast volume may include one or more of an excess amount of ballast for the particular railroad track segment, a deficient amount of ballast for the particular railroad track segment, and a net amount of ballast for the particular railroad track segment. The ballast volume may then be displayed on an electronic display and utilized by ballast maintenance personnel during ballast maintenance operations for the particular railroad track segment. As a result, ballast maintenance personnel may have a more accurate depiction of the amount of ballast to add or remove from particular railroad track segment. This may increase the overall safety of the railroad track by decreasing derailments caused by improper ballast volumes. Furthermore, the overall efficiency of railroad operations may be improved by taking the guesswork out of how much ballast to purchase for, deliver to, and apply to the particular railroad track segment.

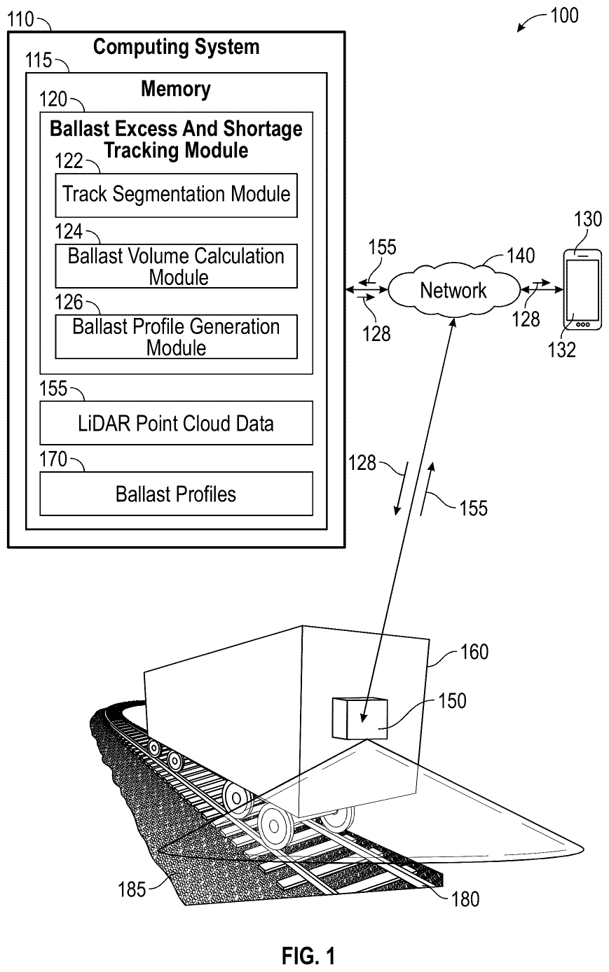

FIG. 1 is a block diagram of an exemplary ballast excess and shortage tracking system 100, according to certain embodiments of the present disclosure. As shown in FIG. 1, certain embodiments of ballast excess and shortage tracking system 100 may include a computing system 110, a ballast excess and shortage tracking module 120, a client system 130, a network 140, and a LiDAR instrument 150. Computing system 110, ballast excess and shortage tracking module 120, client system 130, and LiDAR instrument 150 are all communicatively coupled with each other using any appropriate wired or wireless communication system or network (e.g., network 140). Computing system 110 includes a computer processor (e.g., processor 1102) and memory 115 that stores ballast excess and shortage tracking module 120, LiDAR point cloud data 155, and ballast profiles 170. Client system 130 includes an electronic display for displaying a user interface 132. These components, and their individual components, may cooperatively operate to provide functionality in accordance with the discussion herein.

It is noted that the functional blocks, and components thereof, of ballast excess and shortage tracking system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of ballast excess and shortage tracking system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of ballast excess and shortage tracking system 100 are provided for purposes of illustration, rather than by way of limitation and that functionalities described as being provided by different functional blocks may be combined into a single component or may be provided via computing resources disposed in a cloud-based environment accessible over a network, such as network 140.

In general, ballast excess and shortage tracking system 100 determines volumes of ballast 185 (i.e., ballast volume 128) for railroad track 180 based on a comparison between ballast profiles 170 and LiDAR point cloud data 155 captured by LiDAR instrument 150. For example, certain embodiments of ballast excess and shortage tracking system 100 may first segment railroad track 180 into a plurality of railroad track segments (e.g., railroad track segments 310). The segmentation of railroad track 180 into the plurality of railroad track segments may be based on, for example, railroad track obstructions such as bridges, crossings, and signals (e.g., railroad track obstructions 320). Each railroad track segment may be a predetermined length of railroad track such as between 200-300 feet. After railroad track 180 has been segmented into railroad track segments, ballast excess and shortage tracking system 100 may compare LiDAR point cloud data 155 for each particular railroad track segment to a ballast profile surface mesh (e.g., ballast profile surface mesh 500 generated from ballast profiles 170) for the particular railroad track segment in order to determine a ballast volume 128 for the particular railroad track segment. The ballast volume 128 may include one or more of an excess amount of ballast 185 for the particular railroad track segment, a deficient amount of ballast 185 for the particular railroad track segment, and a net amount of ballast 185 for the particular railroad track segment. The ballast volume 128 may then be displayed on an electronic display (e.g., client system 130) and utilized by ballast maintenance personnel during ballast maintenance operations for the particular railroad track segment. In some embodiments, ballast volume 128 may be electronically transmitted to rail vehicle 160 to automatically control the dispensing of ballast 185 to locations identified by the system as having a ballast shortage. As a result, ballast maintenance personnel may have a more accurate depiction of the amount of ballast to add or remove from particular railroad track segment. This may increase the overall safety of the railroad track by decreasing derailments caused by improper ballast volumes. Furthermore, the overall efficiency of railroad operations may be improved by taking the guesswork out of how much ballast to purchase for, deliver to, and apply to the particular railroad track segment.

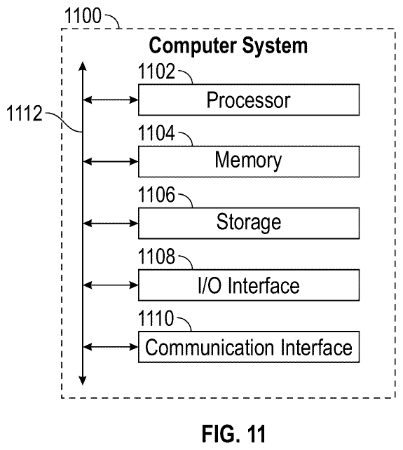

Computing system 110 may be any appropriate computing system in any suitable physical form. As example and not by way of limitation, computing system 110 may be an embedded computer system, a system-on-chip (SOC), a single-board computer system (SBC) (such as, for example, a computer-on-module (COM) or system-on-module (SOM)), a desktop computer system, a laptop or notebook computer system, a mainframe, a mesh of computer systems, a mobile telephone, a personal digital assistant (PDA), a server, a tablet computer system, an augmented/virtual reality device, or a combination of two or more of these. Where appropriate, computing system 110 may include one or more computer systems; be unitary or distributed; span multiple locations; span multiple machines; span multiple data centers; or reside in a cloud, which may include one or more cloud components in one or more networks. Where appropriate, computing system 110 may perform without substantial spatial or temporal limitation one or more steps of one or more methods described or illustrated herein. As an example, and not by way of limitation, computing system 110 may perform in real time or in batch mode one or more steps of one or more methods described or illustrated herein. Computing system 110 may perform at different times or at different locations one or more steps of one or more methods described or illustrated herein, where appropriate. A particular example of a computing system 110 is described in reference to FIG. 11.

Computing system 110 includes one or more memory units/devices 115 (collectively herein, “memory 115”) that may store ballast excess and shortage tracking module 120. Ballast excess and shortage tracking module 120 may be a software module/application utilized by computing system 110 to compare LiDAR point cloud data 155 with ballast profiles 170 in order to determine ballast volume 128, as described herein. Ballast excess and shortage tracking module 120 represents any suitable set of instructions, logic, or code embodied in a computer-readable storage medium. For example, ballast excess and shortage tracking module 120 may be embodied in memory 115, a disk, a CD, or a flash drive. In particular embodiments, ballast excess and shortage tracking module 120 may include instructions (e.g., a software application) executable by a computer processor to perform some or all of the functions described herein. In some embodiments, ballast excess and shortage tracking module 120 may include a track segmentation module 122, a ballast volume calculation module 124, and a ballast profile generation module 126. In general, track segmentation module 122 determines railroad track segments (e.g., railroad track segments 310) of railroad track 180, ballast volume calculation module 124 calculates ballast volume 128, and ballast profile generation module 126 generates ballast profiles 170. The operations of track segmentation module 122, ballast volume calculation module 124, and ballast profile generation module 126 are discussed in more detail below.

Ballast volume 128 is an amount of ballast 185 for railroad track 180 that is calculated by ballast excess and shortage tracking module 120 using LiDAR point cloud data 155 and ballast profiles 170. In some embodiments, ballast volume 128 includes one or more of an excess amount of ballast 185 for a particular railroad track segment of railroad track 180, a deficient amount of ballast 185 for a particular railroad track segment of railroad track 180, and a net amount of ballast 180 for a particular railroad track segment of railroad track 180. In some embodiments, ballast volume 128 corresponds to a particular side of railroad track 180 (i.e., the left side of railroad track 180 or the right side of railroad track 180). In some embodiments, ballast volume 128 is measured in tonnage of ballast 185 or a cubic volume of ballast 185. In some embodiments, ballast volume 128 is electronically transmitted (e.g., across network 140) for display on client system 130. In some embodiments, ballast volume 128 is electronically transmitted and displayed within an alert or notification. In some embodiments, ballast volume 128 may be electronically transmitted to rail vehicle 160 to automatically control the dispensing of ballast 185 to locations identified by the system as having a ballast shortage.

In some embodiments, ballast excess and shortage tracking module 120 may send one or more electronic alerts (e.g., a text message and the like) to client system 130 (e.g., a smartphone, a computer, a tablet, etc.) to notify personnel of ballast volume 128. For example, ballast excess and shortage tracking module 120 may send an alert or notification to client system 130 that enables a user to view ballast volume 128. A user may view the alert and take any appropriate action (e.g., add or remove ballast 185 to railroad track 180). As a result, the safety and efficiency of operations of railroad track 180 may be improved.

Client system 130 is any appropriate user device for communicating with components of ballast excess and shortage tracking system 100 over network 140 (e.g., the internet). In particular embodiments, client system 130 may be an electronic device including hardware, software, or embedded logic components or a combination of two or more such components and capable of carrying out the appropriate functionalities implemented or supported by client system 130. As an example, and not by way of limitation, a client system 130 may include a computer system (e.g., computer system 1100) such as a desktop computer, notebook or laptop computer, netbook, a tablet computer, e-book reader, GPS device, camera, personal digital assistant (PDA), handheld electronic device, cellular telephone, smartphone, smartwatch, augmented/virtual reality device such as wearable computer glasses, other suitable electronic device, or any suitable combination thereof. This disclosure contemplates any suitable client system 130. A client system 130 may enable a network user at client system 130 to access network 140. A client system 130 may enable a user to communicate with other users at other client systems 130. Client system 130 may include an electronic display that displays graphical user interface 132, a processor such processor 1102, and memory such as memory 1104.

Network 140 allows communication between and amongst the various components of ballast excess and shortage tracking system 100. This disclosure contemplates network 140 being any suitable network operable to facilitate communication between the components of ballast excess and shortage tracking system 100. Network 140 may include any interconnecting system capable of transmitting audio, video, signals, data, messages, or any combination of the preceding. Network 140 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network.

LiDAR instrument 150 is any LiDAR system or device that is capable of scanning ballast 185, railroad track 180, and the environment around railroad track 180 as rail vehicle 160 traverses railroad track 180. In some embodiments, ballast excess and shortage tracking system 100 includes a single LiDAR instrument 150 that is attached to rail vehicle 160. In other embodiments, ballast excess and shortage tracking system 100 includes more than one LiDAR instrument 150 attached to rail vehicle 160. In general, LiDAR instrument 150 produces LiDAR point cloud data 155 and electronically transmits LiDAR point cloud data 155 to computing system 110.

LiDAR point cloud data 155 is data captured by LiDAR instrument 150 while rail vehicle 160 traverses railroad track 180. In some embodiments, LiDAR point cloud data 155 captured by LiDAR instrument 150 indicates the locations of objects and surfaces within a railroad track environment (e.g., railroad track 180, ballast 185, and the physical area surrounding railroad track 180). Each data point within LiDAR point cloud data 155 may have an associated set of coordinates that spatially locate the point in a three-dimensional environment. The data points within LiDAR point cloud data 155 are compared to ballast profiles 170 in order to determine ballast volume 128, as described in more detail below.

Rail vehicle 160 is any appropriate vehicle or object that is able to traverse railroad track 180. In some embodiments, for example, rail vehicle 160 may be a railcar or a locomotive of a train. In other embodiments, rail vehicle 160 may be any other appropriate vehicle (e.g., an automobile) that is configured to traverse railroad track 180.

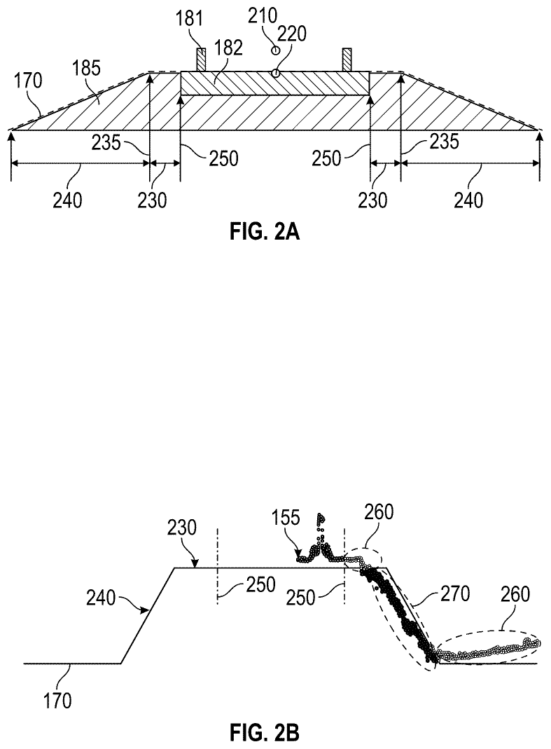

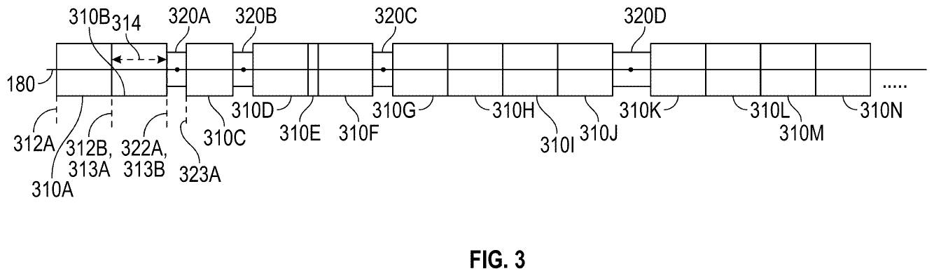

Ballast profiles 170 are files and/or any data in any appropriate format that indicate a desired or ideal level of ballast 185 around railroad track 180. An example of a ballast profile 170 is illustrated in FIGS. 2A and 2B. In general, each ballast profile 170 provides a cross-sectional view of an ideal surface level of ballast 185 around railroad track 180 at a specific centerline point 210 along railroad track 180. Ballast excess and shortage tracking system 100 may utilize any number of centerline points 210 and at any interval along railroad track 180. For example, track centerline points 210 may be located every foot along railroad track 180. Using this example interval, ballast excess and shortage tracking system 100 includes a specific ballast profile 170 for every foot of railroad track 180. In other embodiments, however, any other appropriate interval and thus any number of ballast profiles 170 may be utilized by ballast excess and shortage tracking system 100 (e.g., a ballast profile 170 for every half foot of railroad track 180, for every ten feet of railroad track 180, and the like).

As illustrated in FIGS. 2A and 2B, each ballast profile 170 may include a profile pivot point 220, a shoulder 230 for each side of railroad track 180, and a slope 240 for each side of railroad track 180. Profile pivot point 220 may be aligned with track centerline point 210 and may be located by ballast excess and shortage tracking system 100 at any appropriate distance below track centerline point 210. Shoulders 230 of ballast profile 170 are the horizontal surfaces adjacent to the outsides of rails 181 (i.e., the left and right sides) of railroad track 180. In some embodiments, each shoulder 230 has a width that extends away from tie edge 250 and ends at a shoulder edge 235. For example, each shoulder 230 may be 12-15 inches wide. Slope 240 begins at shoulder edge 235 and slopes away from shoulder edge 235 at a predetermined ratio. For example, slope 240 may slope away from shoulder edge 235 at a 2:1 ratio. Slope 240 may have any appropriate width (e.g., four feet). Specific techniques for generating ballast profiles 170 that may be utilized by some embodiments of ballast excess and shortage tracking system 100 are discussed in more detail below in reference to ballast profile generation module 126.

As will be discussed in more detail below, ballast excess and shortage tracking system 100 utilizes ballast profiles 170 in comparison with LiDAR point cloud data 155 in order to determine ballast shortages and excesses for a specific segment of railroad track 180 (e.g., railroad track segments 310). For example, FIG. 2B illustrates ballast excesses 260 and ballast shortages 270 that have been identified by ballast excess and shortage tracking system 100 at a specific track centerline point 210. In this example, ballast excess and shortage tracking system 100 has identified two areas of ballast excesses 260: one area immediately outside tie edge 250, and one area beyond the end of slope 240. In addition, ballast excess and shortage tracking system 100 has identified one area of ballast shortage 270 that is below slope 240. As will be described in more detail below in reference to ballast volume calculation module 124, ballast excess and shortage tracking system 100 utilizes various techniques to calculate ballast excesses 260 and ballast shortages 270 along a length of a specific segment of railroad track 180 in order to determine a ballast volume 128 for that specific segment of railroad track 180.

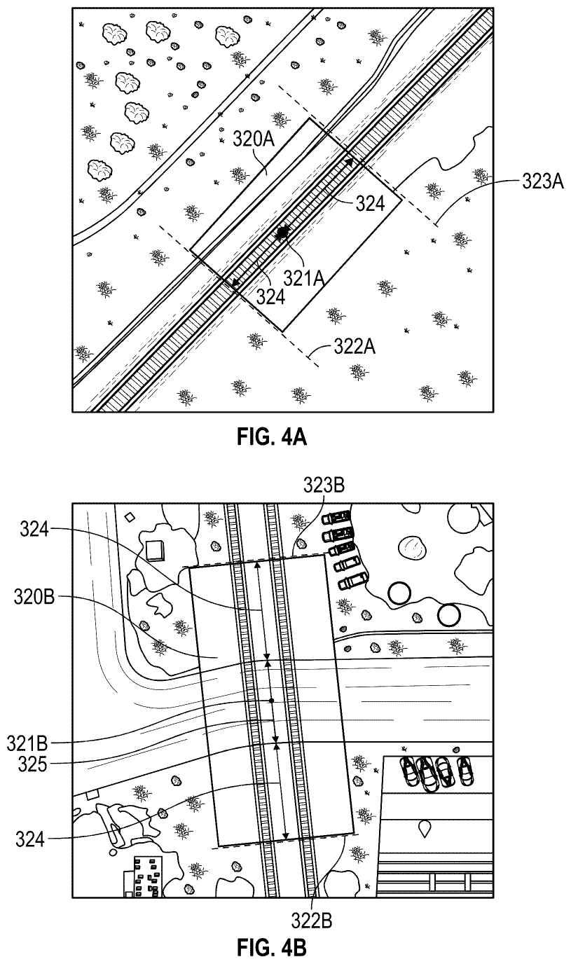

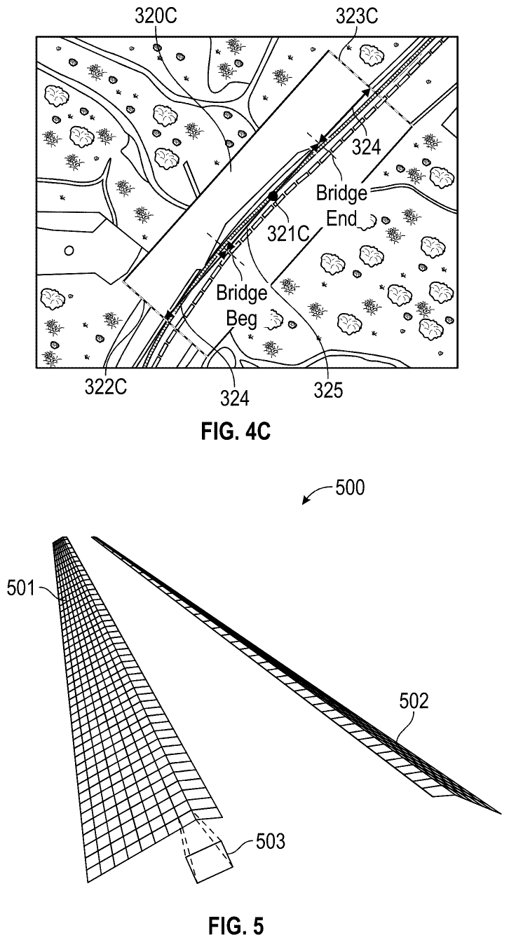

Track segmentation module 122 may be a software module/application within ballast excess and shortage tracking module 120 that is utilized by ballast excess and shortage tracking system 100 to segment railroad track 180, as described in more detail below. Track segmentation module 122 represents any suitable set of instructions, logic, or code embodied in a computer-readable storage medium. For example, track segmentation module 122 may be embodied in memory 115, a disk, a CD, or a flash drive. In particular embodiments, track segmentation module 122 may include instructions (e.g., a software application) executable by a computer processor to perform some or all of the functions described herein. The functionality of certain embodiments of track segmentation module 122 are described in more detail below in refence to FIGS. 3 and 4A-4C.

FIGS. 3 and 4A-4C illustrate the segmentation of railroad track 180 into railroad track segments 310, according to certain embodiments. In some embodiments, the operations described in reference to FIGS. 3 and 4A-4C are performed by track segmentation module 122 of ballast excess and shortage tracking module 120. In general, ballast excess and shortage tracking system 100 divides railroad track 180 into smaller segments (i.e., railroad track segments 310) to more efficiently and accurately calculate ballast volumes 128. In some embodiments, each railroad track segment 310 is a predetermined length of track and includes a starting milepost and an ending milepost. For example, railroad track segments 310 may be between 200 and 300 feet of railroad track 180. As a specific example, each railroad track segments 310 may be 1/20 of a mile (approximately 264 feet). In other embodiments, railroad track segments 310 may be any other appropriate length according to the specifications of ballast excess and shortage tracking system 100 or user input.

In some embodiments, ballast excess and shortage tracking system 100 determines railroad track segments 310 by first identifying railroad track obstructions 320 along railroad track 180. Railroad track obstructions 320 may include areas of railroad track 180 that do not need ballast maintenance such as bridges, crossings, signals, switches, and the like. Each railroad track obstruction 320 may include an obstruction centerpoint 321 that has an associated geographic position (e.g., GPS coordinates, milepost, etc.). In the illustrated embodiment of FIG. 3, railroad track 180 includes railroad track obstructions 320A-320D and obstruction centerpoints 321A-321D. Railroad track obstructions 320A and 320B are signals (illustrated in more detail in FIG. 4A), railroad track obstruction 320C is a railroad crossing such as a street (illustrated in more detail in FIG. 4B), and railroad track obstruction 320D is a bridge (illustrated in more detail in FIG. 4C). Railroad track obstructions 320 may be identified along railroad track 180 using any appropriate technique or data. For example, geographic information system (GIS) data from a GIS database may be accessed and utilized by ballast excess and shortage tracking system 100 to identify railroad track obstructions 320 and their associated obstruction centerpoints 321.

After identifying railroad track obstructions 320 along railroad track 180, ballast excess and shortage tracking system 100 may utilize various techniques in order to determine the beginning and ending locations (e.g., mileposts or GPS coordinates) of railroad track obstructions 320. In some embodiments, the beginning and ending points of railroad track obstructions 320 may be accessed from a database. In other embodiments, ballast excess and shortage tracking system 100 may calculate the beginning and ending points of railroad track obstructions 320. In embodiments where ballast excess and shortage tracking system 100 calculates the beginning and ending points of railroad track obstructions 320, ballast excess and shortage tracking system 100 may first determine a type of railroad track obstruction 320. For example, if railroad track obstruction 320 is determined to be a signal, predetermined buffer values 324 may be used by ballast excess and shortage tracking system 100 to calculate the beginning and ending points of railroad track obstructions 320 as illustrated below in reference to FIG. 4A. As another example, if railroad track obstruction 320 is determined to be a crossing or a bridge, predetermined buffer values 324 along with obstruction widths 325 (e.g., a width of the crossing or bridge) may be used by ballast excess and shortage tracking system 100 to calculate the beginning and ending points of railroad track obstructions 320 as illustrated below in reference to FIGS. 4B and 4C.

As a first example, FIG. 4A illustrates a railroad track obstruction 320A that has been determined to be a signal. This determination may be made by some embodiments of ballast excess and shortage tracking system 100, for example, by accessing metadata for railroad track obstruction 320A in a database or memory 115. Signal obstruction 320A includes an obstruction centerpoint 321A, an obstruction beginning point 322A, and an obstruction ending point 323A. To determine obstruction beginning point 322A and obstruction ending point 323A of signal obstruction 320A, ballast excess and shortage tracking system 100 may first determine (e.g., from a database or memory 115) a predetermined buffer width 324 from obstruction centerpoint 321A. Ballast excess and shortage tracking system 100 may then add the predetermined buffer width 324 to each side of obstruction centerpoint 321A in order to determine obstruction beginning point 322A and obstruction ending point 323A. In some embodiments, the predetermined buffer width 324 may be any appropriate distance (e.g., five feet, ten feet, twenty feet, twenty-five feet, fifty feet, and the like). In some embodiments, the predetermined buffer width 324 for one side of obstruction centerpoint 321A may be different from the predetermined buffer width 324 for the opposite side of obstruction centerpoint 321A (e.g., for railroad track obstructions 320 that are switches).

As a second example, FIG. 4B illustrates a railroad track obstruction 320B that has been determined to be a crossing. This determination may be made by some embodiments of ballast excess and shortage tracking system 100, for example, by accessing metadata for railroad track obstruction 320B in a database or memory 115. Crossing obstruction 320B includes an obstruction centerpoint 321B, an obstruction beginning point 322B, and an obstruction ending point 323B. To determine obstruction beginning point 322B and obstruction ending point 323B of crossing obstruction 320B, ballast excess and shortage tracking system 100 may first determine (e.g., from a database or memory 115) an obstruction width 325 for crossing obstruction 320B. Next, ballast excess and shortage tracking system 100 may determine (e.g., from a database or memory 115) a predetermined buffer width 324 for crossing obstruction 320B. Ballast excess and shortage tracking system 100 may then add half of obstruction width 325 along with the predetermined buffer width 324 to each side of obstruction centerpoint 321B in order to determine obstruction beginning point 322B and obstruction ending point 323B. In some embodiments, obstruction width 325 and predetermined buffer width 324 may be any appropriate distances (e.g., five feet, ten feet, twenty feet, twenty-five feet, fifty feet, and the like). While the predetermined buffer widths 324 for both sides of obstruction centerpoint 321B may be identical as illustrated in FIG. 4B, in other embodiments, the predetermined buffer width 324 for one side of obstruction centerpoint 321B may be different from the predetermined buffer width 324 for the opposite side of obstruction centerpoint 321B.

As a third example, FIG. 4C illustrates a railroad track obstruction 320C that has been determined to be a bridge. This determination may be made by some embodiments of ballast excess and shortage tracking system 100, for example, by accessing metadata for railroad track obstruction 320C in a database or memory 115. Bridge obstruction 320C includes an obstruction centerpoint 321C, an obstruction beginning point 322C, and an obstruction ending point 323C. To determine obstruction beginning point 322C and obstruction ending point 323C of bridge obstruction 320C, ballast excess and shortage tracking system 100 may first determine (e.g., from a database or memory 115) an obstruction width 325 for bridge obstruction 320C. Next, ballast excess and shortage tracking system 100 may determine (e.g., from a database or memory 115) a predetermined buffer width 324 for bridge obstruction 320C. Ballast excess and shortage tracking system 100 may then add half of obstruction width 325 along with the predetermined buffer width 324 to each side of obstruction centerpoint 321C in order to determine obstruction beginning point 322C and obstruction ending point 323C. In some embodiments, obstruction width 325 and the predetermined buffer width 324 may be any appropriate distances (e.g., five feet, ten feet, twenty feet, twenty-five feet, fifty feet, and the like). While the predetermined buffer widths 324 for both sides of obstruction centerpoint 321C may be identical as illustrated in FIG. 4C, in other embodiments, the predetermined buffer width 324 for one side of obstruction centerpoint 321C may be different from the predetermined buffer width 324 for the opposite side of obstruction centerpoint 321C.

After determining obstruction beginning points 322 and obstruction ending points 323 for each railroad track obstruction 320, ballast excess and shortage tracking system 100 may proceed to determine railroad track segments 310. To do so, ballast excess and shortage tracking system 100 may determine an entire length of railroad track 180 to be segmented. This may include determining beginning and ending points (e.g., mileposts) for the entire railroad track 180 to be segmented. Next, ballast excess and shortage tracking system 100 may subtract the determined widths of railroad track obstructions 320 from the entire length of railroad track 180 to be segmented. This may include utilizing the determined obstruction beginning points 322 and obstruction ending points 323 for each railroad track obstructions 320, as described above. The remaining length of the railroad track 180 to be segmented may then be divided up into railroad track segments 310 according to user input or a predetermined length 314 of railroad track segments 310 stored in memory 115. For example, the remaining length of the railroad track 180 to be segmented may be divided up into segments that are 1/20 of a mile in length.

In some embodiments, ballast excess and shortage tracking system 100 may begin at one endpoint (e.g., an obstruction beginning point 322 or an obstruction ending point 323) of a railroad track obstruction 320 and add on the predetermined length 314 of railroad track segments 310 in order to determine railroad track segments 310. For example, as illustrated in FIG. 3, ballast excess and shortage tracking system 100 may begin at obstruction beginning point 322A of railroad track obstruction 320A in order to determine railroad track segments 310B and 310A. In this example, segment ending point 313B is set to equal obstruction beginning point 322A, and segment beginning point 312B is calculated by adding predetermined length 314 to obstruction beginning point 322A. Likewise, segment ending point 313A is set to equal segment beginning point 312B, and segment beginning point 312A is calculated by adding predetermined length 314 to segment beginning point 312B. This process may be repeated on both sides of railroad track obstruction 320A until another railroad track obstruction 320 or an end of the railroad track 180 to be segmented is reached.

In some embodiments, ballast excess and shortage tracking system 100 may discard or reject generated railroad track segments 310 that are below a predetermined threshold. For example, if a railroad track segment 310 such as railroad track obstruction 320E is generated to have a length that is less than the predetermined threshold (e.g., fifty feet), the railroad track segment 310 may be discarded or otherwise ignored for future processing. In other embodiments, if a railroad track segment 310 such as railroad track obstruction 320E is generated to have a length that is less than the predetermined threshold, the railroad track segment 310 may be appended to an adjacent railroad track obstruction 320. In this example, railroad track obstruction 320E may be appended to either railroad track segment 310D or 310F.

Ballast volume calculation module 124 may be a software module/application within ballast excess and shortage tracking module 120 that is utilized by ballast excess and shortage tracking system 100 to calculate ballast volume 128, as described in more detail below. Ballast volume calculation module 124 represents any suitable set of instructions, logic, or code embodied in a computer-readable storage medium. For example, ballast volume calculation module 124 may be embodied in memory 115, a disk, a CD, or a flash drive. In particular embodiments, ballast volume calculation module 124 may include instructions (e.g., a software application) executable by a computer processor to perform some or all of the functions described herein. The functionality of certain embodiments of ballast volume calculation module 124 are described in more detail below in refence to FIGS. 5-8.

FIGS. 5-8 illustrate the calculation of ballast excesses and ballast shortages (e.g., ballast volume 128) along a railroad track segment 310 of railroad track 180, according to certain embodiments. In some embodiments, the operations described in reference to FIGS. 5-8 are performed by ballast volume calculation module 124 of ballast excess and shortage tracking module 120. In general, ballast excess and shortage tracking system 100 utilizes ballast profiles 170 and LiDAR point cloud data 155 captured by LiDAR instrument 150 in order to calculate ballast volume 128 for each railroad track obstruction 320. As a first step, particular embodiments of ballast excess and shortage tracking system 100 generate a ballast profile surface mesh 500 as illustrated in FIG. 5. In general, ballast profile surface mesh 500 is a three-dimensional surface profile that is generated by ballast excess and shortage tracking system 100 using ballast profiles 170 for a particular railroad track segment 310. To generate ballast profile surface mesh 500 for a particular railroad track segment 310, ballast excess and shortage tracking system 100 may determine and access ballast profiles 170 that correspond to the particular railroad track segment 310. For illustrative purposes only, consider railroad track segment 310A that includes segment beginning point 312A and segment ending point 313B as illustrated in FIG. 3. To generate ballast profile surface mesh 500 for railroad track segment 310A, ballast excess and shortage tracking system 100 may determine and access ballast profiles 170 that correspond to some or all of track centerline points 210 that are between segment beginning point 312A and segment ending point 313B. If segment beginning point 312A and segment ending point 313B are mileposts, for example, ballast excess and shortage tracking system 100 may compare the mileposts associated with track centerline points 210 to a milepost range between segment beginning point 312A and segment ending point 313B in order to determine all centerline points 210 within the milepost range. The ballast profiles 170 that are associated with the centerline points 210 within the milepost range of railroad track segment 310A may then be accessed and utilized to generate ballast profile surface mesh 500 for railroad track segment 310A.

In some embodiments, ballast excess and shortage tracking system 100 generates ballast profile surface mesh 500 for a particular railroad track segment 310 by stitching together the ballast profiles 170 that are associated with the particular railroad track segment 310. For example, the ballast profiles 170 associated with the particular railroad track segment 310 may be aligned sequentially along a direction of railroad track 180. An outline of the aligned ballast profiles 170 may then be used to generate the overall shape of ballast profile surface mesh 500. In some embodiments, each ballast profile surface mesh 500 includes two sections: a left ballast profile mesh 501 and a right ballast profile mesh 502. In some embodiments, ballast profile surface mesh 500 is subdivided into multiple mesh polygons 503. Mesh polygons 503 may have any appropriate shape (e.g., square, rectangle, etc.) and may correspond to any appropriate dimensions (e.g., one-foot sides).

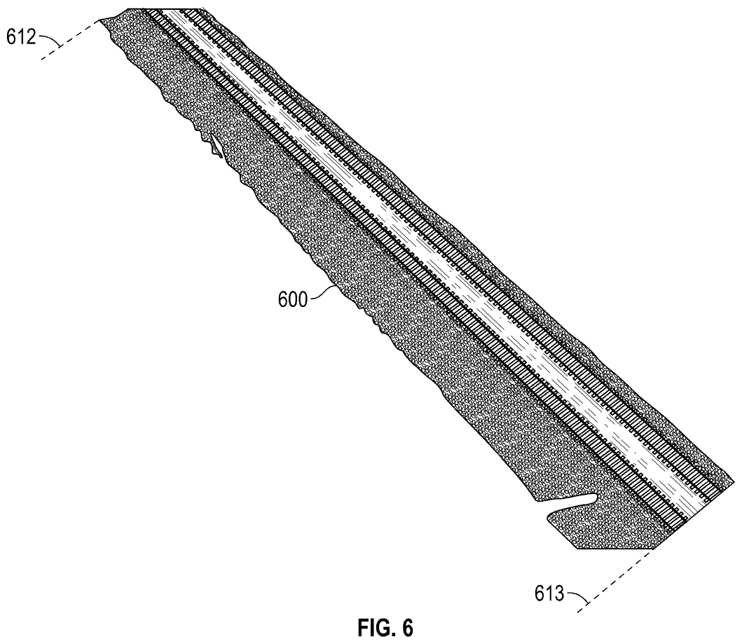

In addition to generating ballast profile surface mesh 500 for each particular railroad track segment 310, certain embodiments of ballast excess and shortage tracking system 100 determine a portion of LiDAR point cloud data 155 that corresponds to the particular railroad track segment. When rail vehicle 160 traverses railroad track 180, LiDAR instrument 150 captures and transmits LiDAR point cloud data 155 that shows the locations of objects and surfaces within the environment around and including railroad track 180. Because railroad track 180 may extend across long distances, LiDAR point cloud data 155 may become excessively large. This may cause extended processing times and may require special and expensive computing systems to handle the processing of such large amounts of data. To mitigate these problems and to improve the efficiency of ballast excess and shortage tracking system 100, certain embodiments of ballast excess and shortage tracking system 100 clip or segment LiDAR point cloud data 155 according to the particular railroad track segments 310 under analysis. For example, FIG. 6 illustrates a LiDAR point cloud data segment 600 that has been segmented from LiDAR point cloud data 155. LiDAR point cloud data segment 600 includes a LiDAR segment beginning point 612 and a LiDAR segment ending point 613. LiDAR segment beginning point 612 may correspond to segment beginning point 312 of a particular railroad track segment 310, and LiDAR segment ending point 613 may correspond to segment ending point 313 of a particular railroad track segment 310 (i.e., LiDAR segment beginning point 612 may have an identical physical location (e.g., milepost) along railroad track 180 as segment beginning point 312, and LiDAR segment ending point 613 may have an identical physical location (e.g., milepost) along railroad track 180 as segment ending point 313). Once ballast excess and shortage tracking system 100 determines LiDAR segment beginning point 612 and LiDAR segment ending point 613 for a particular railroad track segment 310, the remaining data within LiDAR point cloud data 155 that is not between LiDAR segment beginning point 612 and LiDAR segment ending point 613 may be discarded when processing the particular railroad track segment 310.

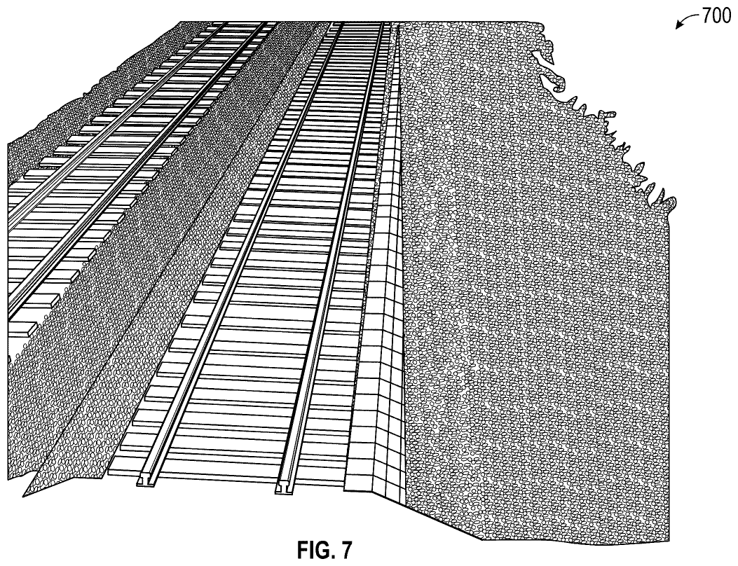

In some embodiments, once ballast profile surface mesh 500 and LiDAR point cloud data segment 600 are generated for a particular railroad track segment 310, ballast excess and shortage tracking system 100 generates an overlay 700 for the particular railroad track segment 310. Overlay 700 may be electronically communicated (e.g., across network 140) for display on any appropriate electronic display such as client system 130. For example, FIG. 7 illustrates an overlay 700 generated by ballast excess and shortage tracking system 100 for a particular railroad track segment 310. In general, overlay 700 displays ballast profile surface mesh 500 superimposed over LiDAR point cloud data segment 600 for a particular railroad track segment 310. Overlay 700 allows a user (e.g., ballast maintenance personnel) to quickly and visually understand the areas around railroad track 180 that need ballast 185 (i.e., the areas where ballast profile surface mesh 500 is visible) or areas around railroad track 180 that have excess ballast 185 (i.e., the areas where LiDAR point cloud data 155 is visible). In the illustrated example of FIG. 7, for example, overlay 700 shows that an area along the right-side shoulder of railroad track 180 has a ballast shortage, while the remaining areas have a ballast surplus. As a result, users such as ballast maintenance personnel may more quickly and efficiently identify areas needed for ballast maintenance.

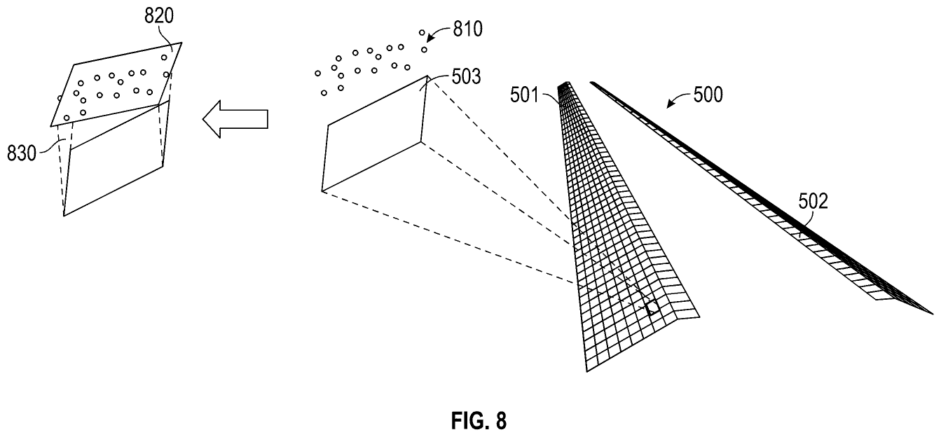

Once ballast profile surface mesh 500 and LiDAR point cloud data segment 600 are generated for a particular railroad track segment 310, some embodiments of ballast excess and shortage tracking system 100 compare ballast profile surface mesh 500 to the ballast mesh to LiDAR point cloud data segment 600 for the particular railroad track segment in order to calculate ballast volume 128. For example, FIG. 8 illustrates comparing ballast profile surface mesh 500 to the LiDAR point cloud data segment 600 for the particular railroad track segment in order to calculate ballast volume 128. As illustrated in FIG. 8, some embodiments compare each mesh polygon 503 of ballast profile surface mesh 500 to corresponding data points 810 within LiDAR point cloud data segment 600. In these embodiments, ballast excess and shortage tracking system 100 may find an average of data points 810 corresponding to mesh polygon 503 in order to generate a plane 820. Plane 820 may be located at a distance from mesh polygon 503 that is an average distance between data points 810 and mesh polygon 503. Once plane 820 is generated for data points 810 corresponding to mesh polygon 503, ballast excess and shortage tracking system 100 may generate a virtual voxel 830 between mesh polygon 503 and plane 820. Ballast excess and shortage tracking system 100 may repeat this process for all mesh polygons 503 of ballast profile surface mesh 500, thereby generating a voxel 830 for all mesh polygons 503.

Once ballast excess and shortage tracking system 100 generates voxels 830 for all mesh polygons 503 of ballast profile surface mesh 500, ballast excess and shortage tracking system 100 may calculate a ballast volume 128 for the particular railroad track segment 310. In some embodiments, ballast excess and shortage tracking system 100 calculates separate ballast volumes 128 for left ballast profile mesh 501 and right ballast profile mesh 502. To calculate ballast volume 128 for ballast profile surface mesh 500, certain embodiments of ballast excess and shortage tracking system 100 calculate the volumes of all voxels 830. To calculate a total excess of ballast 185 for railroad track segment 310, the volumes of all voxels 830 that are above ballast profile surface mesh 500 are added together. To calculate a total shortage of ballast 185 for railroad track segment 310, the volumes of all voxels 830 that are below ballast profile surface mesh 500 are added together. To calculate a net amount of ballast 185 for the particular railroad track segment 310, the total excess of ballast 185 and the total shortage of ballast 185 for the particular railroad track segment 310 are added together. In some embodiments, ballast excess and shortage tracking system 100 may use the calculated ballast volume 128 (e.g., the total excess of ballast 185, the total shortage of ballast 185, and the net amount of ballast 185) to calculate a tonnage of ballast 185 for the particular railroad track segments 310. For example, the calculated ballast volumes 128 may be multiplied by a stored ballast density constant in order to calculate a tonnage amount of ballast 185 for the particular railroad track segments 310.

Some embodiments of ballast excess and shortage tracking system 100 display ballast volume 128 (e.g., the total excess of ballast 185, the total shortage of ballast 185, and the net amount of ballast 185 in tonnage or cubic volume) for the particular railroad track segment 310 on an electronic display. For example, ballast excess and shortage tracking system 100 may electronically transmit ballast volume 128 across network 140 for display on client system 130.

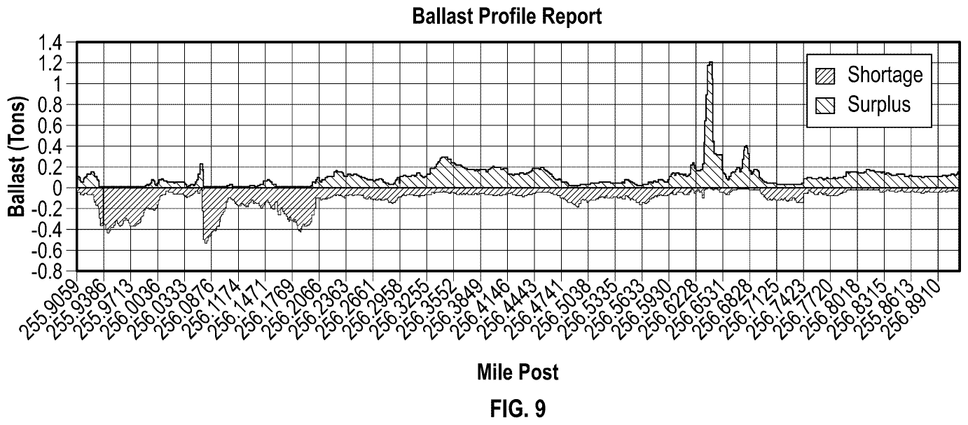

In addition, some embodiments of ballast excess and shortage tracking system 100 generate and electronically display (e.g., on client system 130) a ballast profile report 900 as illustrated in FIG. 9. Ballast profile report 900, in general, graphically illustrates ballast excesses and shortages for a particular railroad track segment 310. In the illustrated example of FIG. 9, for example, ballast profile report 900 shows ballast shortages and surpluses (in tons) for a railroad track segment 310 that begins at milepost 255.9059 and ends at milepost 256.8910. The ballast surpluses are shown above the horizontal line at zero tons, and the ballast shortages are shown below the horizontal line at zero tons. As a result, users may quickly ascertain areas of ballast shortages and surpluses along railroad track segment 310.

In operation, and in reference to FIGS. 1-8, ballast excess and shortage tracking system 100 determines excesses and shortages of ballast 185 of railroad track 180 based on a comparison between LiDAR point cloud data 155 and ballast profiles 170 for individual segments of railroad track 180. To do so, some embodiments of ballast excess and shortage tracking system 100 may first segment railroad track 180 into a plurality of railroad track segments 310. Each railroad track segments 310 may be a predetermined length of railroad track 180 such as between 200-300 feet (e.g., 1/20^{th} of a mile).

To segment railroad track 180 into railroad track segments 310, certain embodiments of ballast excess and shortage tracking system 100 utilize track segmentation module 122 to determine a plurality of railroad track obstructions 320 of railroad track 180. Railroad track obstructions 320 may include, for example, bridges, crossings, switches, signals, and the like. Next, ballast excess and shortage tracking system 100 may compute an obstruction beginning point 322 and an obstruction ending point 323 for each of the railroad track obstructions 320. Obstruction beginning points 322 and obstruction ending points 323 may be, for example, mileposts along railroad track 180 and may be calculated using one or both of predetermined buffer values 324 and obstruction widths 325, as described above. Next, ballast excess and shortage tracking system 100 may determine railroad track segments 310 by calculating a segment beginning point 312 and a segment ending point 313 for each of the railroad track segments 310. The segment beginning points 312 and segment ending points 313 for each of the railroad track segments 310 may be calculated using predetermined length 324 and one or more of obstruction beginning points 322 and obstruction ending points 323 of railroad track obstructions 320, as described above.

After railroad track 180 has been segmented into railroad track segments 310, ballast excess and shortage tracking system 100 may compare LiDAR point cloud data 155 for each particular railroad track segments 310 to a ballast profile surface mesh 500 for the particular railroad track segments 310 in order to determine a ballast volume 128 for the particular railroad track segment 310. The calculated ballast volume 128 for each particular railroad track segment 310 may include one or more of an excess amount of ballast for the particular railroad track segment, a deficient amount of ballast for the particular railroad track segment, and a net amount of ballast for the particular railroad track segment (in tons or cubic volume). Ballast volume 128 may then be electronically transmitted and displayed on an electronic display such as client system 130. Ballast volume 128 may be utilized by ballast maintenance personnel during ballast maintenance operations for the particular railroad track segment 310. As a result, ballast maintenance personnel may have a more accurate depiction of the amount of ballast to add or remove from each particular railroad track segment 310. This may increase the overall safety of the railroad track by decreasing derailments caused by improper ballast volumes. Furthermore, the overall efficiency of railroad operations may be improved by taking the guesswork out of how much ballast 185 to purchase for, deliver to, and apply to the particular railroad track segment 310.

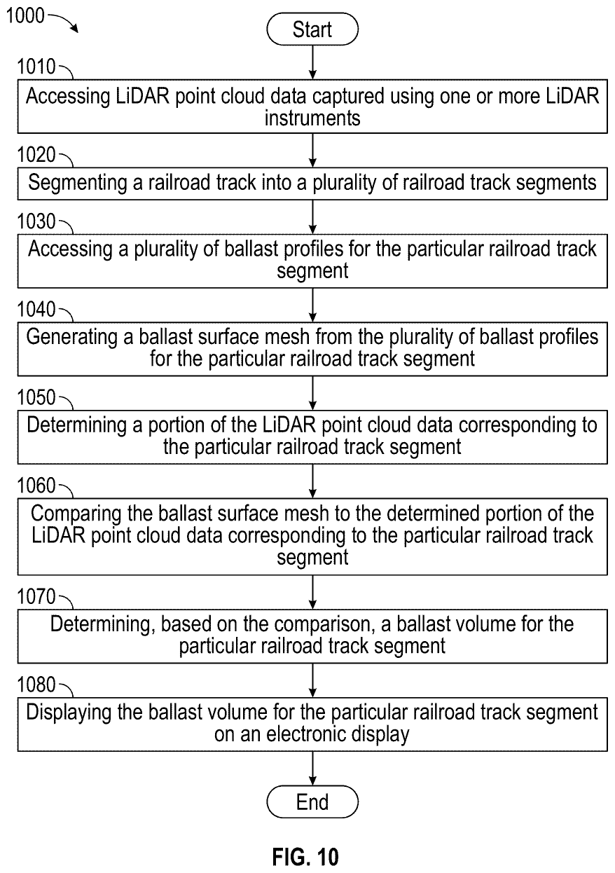

FIG. 10 is a chart illustrating a method 1000 for determining railroad ballast volumes using LiDAR, according to particular embodiments. In some embodiments, method 1000 may be performed by ballast excess and shortage tracking module 120 of ballast excess and shortage tracking system 100. At step 1010, method 1000 accesses LiDAR point cloud data captured using one or more LiDAR instruments. The LiDAR point cloud data includes locations of objects and surfaces within a railroad track environment. In some embodiments, the LiDAR point cloud data is LiDAR point cloud data 155. In some embodiments, the one or more LiDAR instruments are LiDAR instruments 150. In some embodiments, the one or more LiDAR instruments are coupled to a rail vehicle such as rail vehicle 160. In some embodiments, step 1010 further includes capturing the LiDAR point cloud data using the one or more LiDAR instruments that are coupled to the rail vehicle as the rail vehicle traverses the railroad track.

At step 1020, method 1000 segments a railroad track into a plurality of railroad track segments. In some embodiments, the plurality of railroad track segments are railroad track segments 310. In some embodiments, step 1020 includes determining a plurality of railroad track obstructions of the railroad track. The track obstructions may be bridges, crossing, signals, switches, and the like. In some embodiments, the plurality of railroad track obstructions are railroad track obstructions 320 that are determined by accessing a database such as a GIS database.

In some embodiments, step 1020 includes computing an obstruction beginning point and an obstruction ending point for each of the plurality of railroad track obstructions. The obstruction beginning point may be obstruction beginning point 322 and the obstruction ending point may be obstruction ending point 323. The obstruction beginning point and the obstruction ending point may be computed by first determining a type of the railroad track obstruction. For example, if the railroad track obstruction is determined to be a signal, predetermined buffer values (e.g., predetermined buffer values 324) may be added to an obstruction centerpoint (e.g., obstruction centerpoint 321) of the railroad track obstruction. As another example, if the railroad track obstruction is determined to be a crossing or a bridge, the predetermined buffer value along with half of an obstruction width (e.g., obstruction width 325) of the railroad track obstruction may be added to the obstruction centerpoint of the railroad track obstruction in order to calculate the beginning and ending points of the railroad track obstruction.

In some embodiments, step 1020 includes accessing a predetermined length for the plurality of railroad track segments. In some embodiments, the predetermined length is predetermined length 314. In some embodiments, step 1020 includes calculating a segment beginning point and a segment ending point for each of the plurality of railroad track segments using the predetermined length and one or more of the obstruction beginning points and the obstruction ending points of the plurality of railroad track obstructions. In some embodiments, the segment beginning point is segment beginning point 312 and the segment ending point is segment ending point 313. In some embodiments, calculating the segment beginning point includes equating the segment beginning point to either an obstruction beginning point or an obstruction ending point of step 1020. In some embodiments, calculating the segment ending point includes adding the predetermined length (e.g., predetermined length 314) to either an obstruction beginning point or an obstruction ending point of step 1020.

At step 1030, method 1000 accesses a plurality of ballast profiles for the particular railroad track segment. Each ballast profile indicates a desired amount of ballast around the particular railroad track segment at a particular point along particular railroad track segment. In some embodiments, the plurality of ballast profiles are ballast profiles 170.

At step 1040, method 1000 generates a ballast surface mesh from the plurality of ballast profiles of step 1030 for the particular railroad track segment. In some embodiments, the ballast surface mesh is ballast profile surface mesh 500. In some embodiments, the ballast surface mesh is divided into two sides: a left side (e.g., left ballast profile mesh 501) and a right side (e.g., right ballast profile mesh 502). In some embodiments, the ballast surface mesh includes mesh polygons such as mesh polygons 503. In some embodiments, generating the ballast surface mesh for the particular railroad track segment includes determining a plurality of ballast profiles that correspond to the particular railroad track segment by locating ballast profiles that correspond to some or all track centerline points (e.g., track centerline points 210) that are between the segment beginning point and the segment ending point of the particular railroad track segment. In some embodiments, step 1020 includes aligning the determined plurality of ballast profiles in sequential order along the particular railroad track segment and then generating the ballast surface mesh based on an outline of the aligned plurality of ballast profiles.

Steps 1050 through 1080 of method 1000 may be repeated for each particular railroad track segment determined in step 1020. At step 1050, method 1000 determines a portion of the LiDAR point cloud data corresponding to the particular railroad track segment. In some embodiments, method 1000 clips or segments the LiDAR point cloud data according to the segment beginning point and the segment ending point of the particular railroad track segments under analysis. In some embodiments, method 1000 adds a buffer to each end of the segment beginning and points of the particular railroad track segments under analysis when clipping the LiDAR point cloud data (e.g., for calculating curvature as described below).

At step 1060, method 1000 compares the ballast surface mesh to the determined portion of the LiDAR point cloud data corresponding to the particular railroad track segment. In some embodiments, step 1060 includes comparing each mesh polygon of the ballast surface mesh of step 1040 to LiDAR data points (e.g., data points 810) within the determined portion of the LiDAR point cloud data of step 1050. In some embodiments, this step includes finding an average of the LiDAR data points in order to generate a plane (e.g., plane 820). The plane may be located at a distance from the mesh polygon that is an average distance between the data points and the mesh polygon. Once the plane is generated for the data points, method 1000 may generate a virtual voxel (e.g., virtual voxel 830) between the mesh polygon and the plane.

At step 1070, method 1000 determines, based on the comparison of step 1060, a ballast volume for the particular railroad track segment. In some embodiments, the ballast volume is ballast volume 128 and is measured in tonnage or cubic volume. In some embodiments, this step includes computing a segment ballast volume for each mesh polygon of step 1060 by calculating a volume of each virtual voxel. Once segment ballast volumes are calculated for each mesh polygon, method 100 may add all of the computed segment ballast volumes for all of the mesh polygons in order to compute the ballast volume for the particular railroad track segment. In some embodiments, the ballast volume is one or more of an excess amount of ballast for the particular railroad track segment, a deficient amount of ballast for the particular railroad track segment, and a net amount of ballast for the particular railroad track segment.

At step 1080, method 1000 displays the ballast volume for the particular railroad track segment on an electronic display such as client system 130. In some embodiments, step 1080 may include sending the ballast volume for the particular railroad track segment via an alert or a notification. After step 1080, some embodiments of method 1000 may end.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method including the particular steps of the method of FIG. 10, this disclosure contemplates any suitable method including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

FIG. 11 illustrates an example computer system 1100 that can be utilized to implement aspects of the various methods and systems presented herein, according to particular embodiments. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate. In particular embodiments, computing system 110 of FIG. 1 may be implemented as one or more computer systems 1100.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example, and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example, and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example, and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example, and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example, and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example, and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

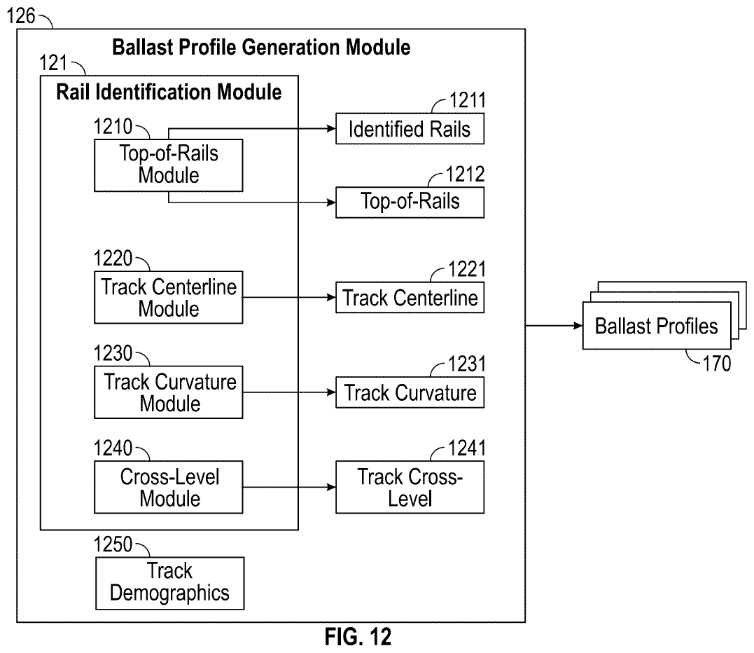

In some embodiments, ballast excess and shortage tracking system 100 utilizes ballast profiles 170 that may be predetermined standard ballast profiles stored in memory 115. In other embodiments, ballast excess and shortage tracking system 100 may generate ballast profiles 170. In these embodiments, ballast excess and shortage tracking system 100 may utilize a ballast profile generation module 126 as illustrated in FIG. 12.

Ballast profile generation module 126 may be a software module/application within ballast excess and shortage tracking module 120 that is utilized by ballast excess and shortage tracking system 100 to generate ballast profiles 170, as described in more detail below. Ballast profile generation module 126 represents any suitable set of instructions, logic, or code embodied in a computer-readable storage medium. For example, ballast profile generation module 126 may be embodied in memory 115, a disk, a CD, or a flash drive. In particular embodiments, ballast profile generation module 126 may include instructions (e.g., a software application) executable by a computer processor to perform some or all of the functions described herein. In some embodiments, ballast profile generation module 126 includes a rail identification module 121, as described in more detail below.

Rail identification module 121 may be a software module/application (either standalone or included within ballast profile generation module 126) that is utilized by ballast profile generation module 126 to analyze LiDAR point cloud data 155 in order to generate track characteristics (e.g., identified rails 1211, top-of-rails 1212, track centerline 1221, track curvature 1231, and track cross-level 1241) of railroad track 180, as described in more detail below. Rail identification module 121 (and each of the modules within rail identification module 121) represents any suitable set of instructions, logic, or code embodied in a computer-readable storage medium. For example, rail identification module 121 may be embodied in memory 115, a disk, a CD, or a flash drive. In particular embodiments, rail identification module 121 may include instructions (e.g., a software application) executable by a computer processor to perform some or all of the functions described herein. In some embodiments, rail identification module 121 includes a top-of-rails module 1210, a track centerline module 1220, a track curvature module 1230, and a cross-level module 1240, as described in more detail below.

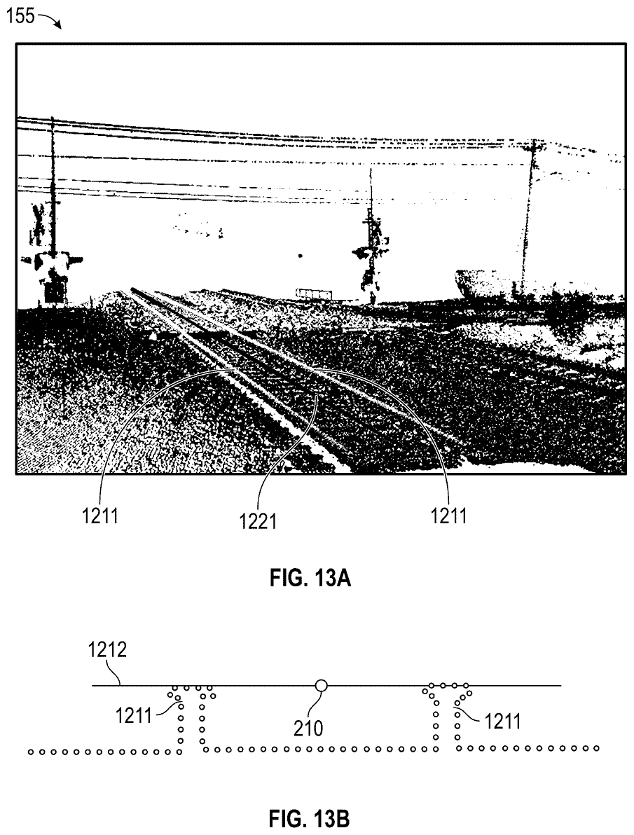

Top-of-rails module 1210 is a software module/application (either standalone or included within rail identification module 121) that analyzes LiDAR point cloud data 155 and generates identified rails 1211 of railroad track 180 and top-of-rails 1212 of the identified rails 1211. Examples of identified rails 1211 and top-of-rails 1212 are illustrated in FIGS. 13A and 13B. In general, identified rails 1211 are the main rails of railroad track 180 in a scene within LiDAR point cloud data 155, and top-of-rails 1212 is the top portion or surface of the identified rails 1211. In some embodiments, top-of-rails module 1210 utilizes an advanced deep neural network to analyze LiDAR point cloud data 155 in order to determine identified rails 1211 and top-of-rails 1212 of railroad track 180 within LiDAR point cloud data 155. As a specific example, some embodiments of track centerline module 1210 utilize the deep-learning model POINTNET to analyze LiDAR point cloud data 155 in order to determine identified rails 1211 and top-of-rails 1212 of railroad track 180 within LiDAR point cloud data 155.

Track centerline module 1220 is a software module/application (either standalone or included within rail identification module 121) that determines a track centerline 1221 of railroad track 180. An example of track centerline 1221 is illustrated in FIG. 13A. In general, track centerline module 1220 utilizes identified rails 1211 and/or top-of-rails 1212 generated by top-of-rails module 1210 to first identify a track centerline point 210 at a predetermined interval along railroad track 180. As a specific example, some embodiments of track centerline module 1220 locate track centerline point 210 (illustrated in FIG. 13B) along top-of-rails 1212 in the middle of the identified rails 1211 (i.e., at the midpoint between the identified rails 1211). This process may be repeated by track centerline module 1220 for any appropriate interval (e.g., a predetermined interval or user-selected interval) along railroad track 180 in order to generate track centerline 1221. For example, track centerline points 210 may be created by track centerline module 1220 every foot along railroad track 180 in order to generate track centerline 1221.

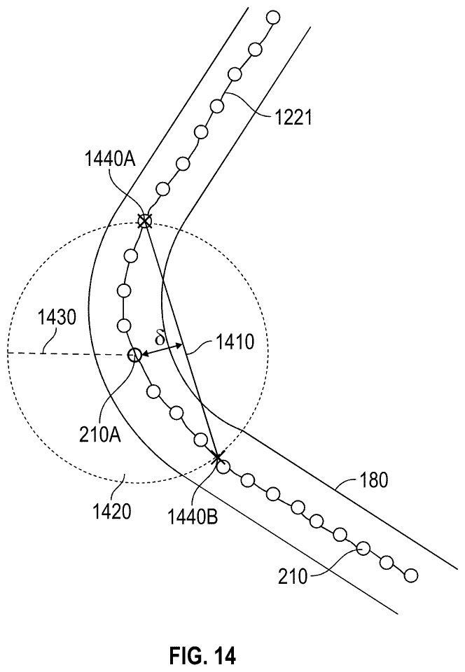

Track curvature module 1230 is a software module/application (either standalone or included within rail identification module 121) that determines a track curvature 1231 of railroad track 180. An example of how some embodiments of track curvature module 1230 determine track curvature 1231 is illustrated in FIG. 14. In some embodiments, track curvature 1231 (κ) is calculated by track curvature module 1230 at each track centerline point 210 (as determined by track centerline module 1220) using a virtual chord 1410. In some embodiments, virtual chord 1410 has a standard fixed length and is moved along track centerline 1221 of railroad track 180. At each position, the distance δ between the middle of virtual chord 1410 and the centerline 1221 of the track is measured. This distance (δ) is linearly converted to the curvature 1231 of the track at that point using the equation: κ=αδ, where α is a constant whose sign value is based on the direction of the curvature with respect to the ascending milepost direction (e.g., −5.5 or +5.5). In other embodiments, a circular buffer 1420 of a predetermined radius 1430 is used to calculate track curvature 1231. In these embodiments, circular buffer 1420 with predetermined radius 1430 (e.g., 25 m) is created at each track centerline point 210 of interest. For example, as illustrated in FIG. 14, circular buffer 1420 is created at centerline point 210A. Next, track curvature module 1230 finds the intersections 1440A and 1440B of circular buffer 1420 with track centerline 1221. Next, track curvature module 1230 connects intersections 1440A and 1440B to create virtual chord 1410. Track curvature module 1230 then calculates distance δ (e.g., in meters) between centerline point 210A and virtual chord 1410. Track curvature 1231 at centerline point 210A may then be calculated by track curvature module 1230 using the equation: κ=αδ, where α is a constant whose sign value is based on the direction of the curvature with respect to the ascending milepost direction (e.g., −5.5 or +5.5).

To be able to calculate the track curvature 1231 for all track centerline points 210 along the entire railroad track segment 310, virtual chord 1410 may need to be placed beyond the ends of the railroad track segment 310 (i.e., the middle of the chord should be at segment beginning point 312/segment ending point 313 of railroad track segment 310). To accommodate this, some embodiments crop LiDAR point cloud data 155 a predetermined buffer distance before and after of the segment of interest in order to make sure enough point cloud data is available before and after the segment for accurate curvature calculations.

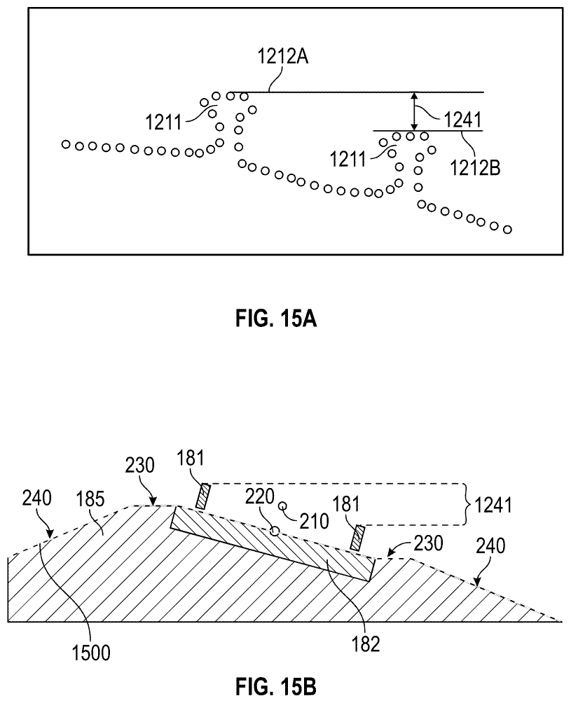

Cross-level module 1240 is a software module/application (either standalone or included within rail identification module 121) that determines a track cross-level 1241 of railroad track 180. An example of how some embodiments of cross-level module 1240 determine track cross-level 1241 is illustrated in FIG. 15A. In some embodiments, cross-level module 1240 first creates a cross section of LiDAR point cloud data 155 at each track centerline point 210 and then reprojects all of the surrounding point cloud data over a 2D plane as illustrated in FIG. 15A. Next, cross-level module 1240 finds top-of-rails 1212A and 1212B as described above with respect to top-of-rails module 1210. Cross-level module 1240 then calculates track cross-level 1241 as the distance between top-of-rails 1212A and top-of-rails 1212B.

In some embodiments, ballast profile generation module 126 utilizes additional track demographics 1250 to generate ballast profiles 170. For example, track demographics 1250 may include one or more of a top of tie 182, a track class of railroad track 180, and a track maximum speed of railroad track 180. In some embodiments, the track class of railroad track 180 and the track maximum speed of railroad track 180 may be accessed from a database or memory 155 by ballast profile generation module 126. In some embodiments, ballast profile generation module 126 may determine track cross-level 1241 of railroad track 180 based on the track class of railroad track 180. In some embodiments, ballast profile generation module 126 may determine the top of tie 182 by determining the top of the ground at each track centerline point 210 (e.g., using LiDAR point cloud data 155).

In general, ballast profile generation module 126 utilizes track centerline 1221, track curvature 1231, track cross-level 1241, and track demographics 1250 to generate ballast profiles 170. In some embodiments, ballast profile generation module 126 may first access a standard ballast profile stored in memory. The standard ballast profile may be based on a nominal or standard class of railroad track 180 without any curves or tangent tracks. Ballast profile generation module 126 may then modify the standard ballast profile according to track demographics 1250 and any determined track curvature 1231 and/or track cross-level 1241 of the specific railroad track segment 310. For example, FIG. 15B illustrates a ballast profile 1500 generated by ballast profile generation module 126 using track demographics 1250 and a determined track curvature 1231 and/or track cross-level 1241 of a particular railroad track segment 310. In this example, the standard ballast profile has been modified and pivoted clockwise about profile pivot point 220 to accommodate a track cross-level 1241 of railroad track 180, a determined track curvature 1231, and/or a track maximum speed of railroad track 180. As illustrated in FIG. 15B, ballast profile 1500 still includes shoulders 230 and slopes 240 as described above. Here, however, the left shoulder 230 is higher than the right shoulder 230 to accommodate the track cross-level 1241 of railroad track 180. Furthermore, the left shoulder 230 is wider than the right shoulder 230 to accommodate determined track curvature 1231. Ballast profile generation module 126 may utilize any appropriate technique for determining the width of shoulder 230 for a determined track curvature 1231 (e.g., via user input or stored data table). For example, for any determined track curvature 1231 above a certain predetermine threshold (e.g., 0.5 degrees), the high shoulder 230 should be fifteen inches wide while the low shoulder 230 should remain twelve inches wide.

In some embodiments, ballast profile generation module 126 may locate profile pivot point 220 a predetermined distance below track centerline point 210. The predetermined distance below track centerline point 210 may be determined, for example, based on a height of rail 181 or via a user-provided distance such as four inches. In other embodiments, ballast excess and shortage tracking system 100 may determine a ground level between rails 181 along tie 182 (e.g., using LiDAR point cloud data 155) and then place profile pivot point 220 at the determined ground level. Ballast excess and shortage tracking system 100 may utilize any appropriate method or technique to locate the ground level for profile pivot point 220 (e.g., from LiDAR point cloud data 155, prior measurements stored in memory 115, etc.).

In some embodiments, ballast profile generation module 126 may adjust the distance between track centerline point 210 and profile pivot point 220 based on a desired amount of lift. For example, ballast excess and shortage tracking system 100 may access (e.g., from memory 115) or otherwise receive a user-supplied lift parameter that indicates how much to lift profile pivot point 220 towards track centerline point 210 (therefore lifting the entire ballast profile 170). In some embodiments, the amount of lift is less than one foot. In some embodiments, the amount of lift is in increments of one-half of an inch.

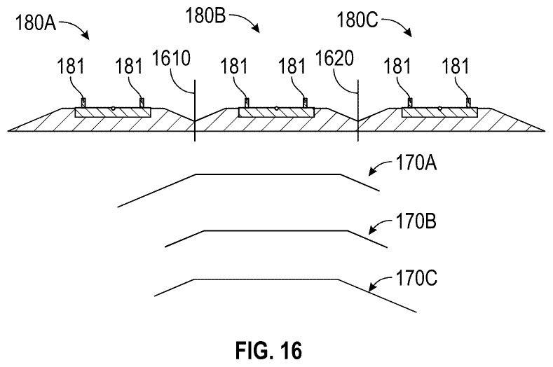

In some embodiments, ballast profile generation module 126 may additionally determine whether there are any adjacent railroad tracks 180 when generating ballast profiles 170. For example, FIG. 16 illustrates adjacent railroad tracks 180A-180C. In this scenario, ballast profile generation module 126 may first determine whether there are any adjacent railroad tracks 180 for a particular railroad track segment 310. To do so, some embodiments of ballast profile generation module 126 utilize an advanced deep neural network to identify the tops of rails 181 of railroad tracks 180A-C within LiDAR point cloud data 155 for railroad track segments 310. As a specific example, some embodiments of ballast profile generation module 126 utilize POINTNET to identify the top of rails 181 of railroad tracks 180A-C within LiDAR point cloud data 155. Once the tops of rails 181 are identified, some embodiments of ballast profile generation module 126 locate and match adjacent tops of rails 181 based on their relative spatial locations in order to determine whether railroad track 180 has any adjacent tracks and which side the adjacent track is located. If ballast profile generation module 126 determines that a railroad track 180 has an adjacent railroad track 180, ballast profile 170 for that track at that location may be modified. For example, slope 240 may be cut short at a midpoint between two adjacent railroad track 180. In the illustrated example of FIG. 16, for example, the right slope 240 of ballast profile 170A for railroad track 180A has been cut short at midpoint 1610 due to adjacent railroad track 180B, and the left slope 240 of ballast profile 170C for railroad track 180C has been cut short at midpoint 1620 due to adjacent railroad track 180B. Similarly, both slopes 240 of ballast profile 170B for railroad track 180B has been cut short at midpoints 1610 and 1620 due to adjacent railroad tracks 180A and 180C.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in the included FIGURES may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system comprising:
one or more LiDAR instruments configured to capture LiDAR point cloud data comprising locations of objects and surfaces within a railroad track environment;
one or more memory units configured to store the LiDAR point cloud data and a plurality of ballast profiles; and
one or more computer processors communicatively coupled to the one or more memory units and configured to:
access the LiDAR point cloud data;
segment a railroad track into a plurality of railroad track segments; and
for each particular railroad track segment of the plurality of railroad track segments:
access, from the plurality of ballast profiles stored in the one or more memory units, a plurality of ballast profiles for the particular railroad track segment, each ballast profile indicating a desired amount of ballast around the particular railroad track segment at a particular point along particular railroad track segment;
generate a ballast surface mesh from the plurality of ballast profiles for the particular railroad track segment;
determine a portion of the LiDAR point cloud data corresponding to the particular railroad track segment;
compare the ballast surface mesh to the determined portion of the LiDAR point cloud data corresponding to the particular railroad track segment;
determine, based on the comparison, a ballast volume for the particular railroad track segment; and
display the ballast volume for the particular railroad track segment on an electronic display.

2. The system of claim 1, wherein the ballast volume for the particular railroad track segment comprises a tonnage or a cubic volume.

3. The system of claim 1, wherein generating the ballast surface mesh for the particular railroad track segment comprises:
determining a plurality of ballast profiles that correspond to the particular railroad track segment;
aligning the determined plurality of ballast profiles in order along the particular railroad track segment; and
generating the ballast surface mesh based on an outline of the aligned plurality of ballast profiles.

4. The system of claim 1, wherein segmenting the railroad track into the plurality of railroad track segments comprises:
determining a plurality of railroad track obstructions of the railroad track;
computing an obstruction beginning point and an obstruction ending point for each of the plurality of railroad track obstructions;
accessing a predetermined length for the plurality of railroad track segments; and
calculating a segment beginning point and a segment ending point for each of the plurality of railroad track segments using the predetermined length and one or more of the obstruction beginning points and the obstruction ending points of the plurality of railroad track obstructions.

5. The system of claim 1, wherein determining the ballast volume for the particular railroad track segment comprises:
dividing the ballast surface mesh into a plurality of mesh polygons;
for each mesh polygon:
compute an average height of actual ballast using the LiDAR point cloud data;
generate a plane using the computed average height of actual ballast;
generate a voxel using the mesh polygon and the generated plane;
compute a segment ballast volume by calculating a volume of the generated voxel; and
adding all of the computed segment ballast volumes for all of the mesh polygons to compute the ballast volume for the particular railroad track segment.

6. The system of claim 1, wherein the one or more LiDAR instruments are coupled to a rail vehicle configured to traverse the railroad track.

7. The system of claim 1, wherein the ballast volume comprises one or more of:
an excess amount of ballast for the particular railroad track segment;
a deficient amount of ballast for the particular railroad track segment; and
a net amount of ballast for the particular railroad track segment.

8. A method by a computing system for determining railroad ballast volumes using light detection and ranging (LiDAR), the method comprising:
accessing LiDAR point cloud data captured using one or more LiDAR instruments, the LiDAR point cloud data comprising locations of objects and surfaces within a railroad track environment;
segmenting a railroad track into a plurality of railroad track segments; and
for each particular railroad track segment of the plurality of railroad track segments:
accessing a plurality of ballast profiles for the particular railroad track segment, each ballast profile indicating a desired amount of ballast around the particular railroad track segment at a particular point along particular railroad track segment;
generating a ballast surface mesh from the plurality of ballast profiles for the particular railroad track segment;
determining a portion of the LiDAR point cloud data corresponding to the particular railroad track segment;
comparing the ballast surface mesh to the determined portion of the LiDAR point cloud data corresponding to the particular railroad track segment;
determining, based on the comparison, a ballast volume for the particular railroad track segment; and
displaying the ballast volume for the particular railroad track segment on an electronic display.

9. The method of claim 8 for determining railroad ballast volumes using LiDAR, wherein the ballast volume for the particular railroad track segment comprises a tonnage or a cubic volume.

10. The method of claim 8 for determining railroad ballast volumes using LiDAR, wherein generating the ballast surface mesh for the particular railroad track segment comprises:
determining a plurality of ballast profiles that correspond to the particular railroad track segment;
aligning the determined plurality of ballast profiles in order along the particular railroad track segment; and
generating the ballast surface mesh based on an outline of the aligned plurality of ballast profiles.

11. The method of claim 8 for determining railroad ballast volumes using LiDAR, wherein segmenting the railroad track into the plurality of railroad track segments comprises:
determining a plurality of railroad track obstructions of the railroad track;
computing an obstruction beginning point and an obstruction ending point for each of the plurality of railroad track obstructions;
accessing a predetermined length for the plurality of railroad track segments; and
calculating a segment beginning point and a segment ending point for each of the plurality of railroad track segments using the predetermined length and one or more of the obstruction beginning points and the obstruction ending points of the plurality of railroad track obstructions.

12. The method of claim 8 for determining railroad ballast volumes using LiDAR, wherein determining the ballast volume for the particular railroad track segment comprises:
dividing the ballast surface mesh into a plurality of mesh polygons;
for each mesh polygon:
compute an average height of actual ballast using the LiDAR point cloud data;
generate a plane using the computed average height of actual ballast;
generate a voxel using the mesh polygon and the generated plane;
compute a segment ballast volume by calculating a volume of the generated voxel; and
adding all of the computed segment ballast volumes for all of the mesh polygons to compute the ballast volume for the particular railroad track segment.

13. The method of claim 8 for determining railroad ballast volumes using LiDAR, wherein the one or more LiDAR instruments are coupled to a rail vehicle, the method further comprising capturing the LiDAR point cloud data using the one or more LiDAR instruments coupled to the rail vehicle as the rail vehicle traverses the railroad track.

14. The method of claim 8 for determining railroad ballast volumes using LiDAR, wherein the ballast volume comprises one or more of:
an excess amount of ballast for the particular railroad track segment;
a deficient amount of ballast for the particular railroad track segment; and
a net amount of ballast for the particular railroad track segment.

15. One or more computer-readable non-transitory storage media embodying instructions that, when executed by a processor, cause the processor to perform operations comprising:
accessing LiDAR point cloud data captured using one or more LiDAR instruments, the LiDAR point cloud data comprising locations of objects and surfaces within a railroad track environment;
segmenting a railroad track into a plurality of railroad track segments; and
for each particular railroad track segment of the plurality of railroad track segments:
accessing a plurality of ballast profiles for the particular railroad track segment, each ballast profile indicating a desired amount of ballast around the particular railroad track segment at a particular point along particular railroad track segment;
generating a ballast surface mesh from the plurality of ballast profiles for the particular railroad track segment;
determining a portion of the LiDAR point cloud data corresponding to the particular railroad track segment;
comparing the ballast surface mesh to the determined portion of the LiDAR point cloud data corresponding to the particular railroad track segment;
determining, based on the comparison, a ballast volume for the particular railroad track segment; and
displaying the ballast volume for the particular railroad track segment on an electronic display.

16. The one or more computer-readable non-transitory storage media of claim 15, wherein the ballast volume for the particular railroad track segment comprises a tonnage or a cubic volume.

17. The one or more computer-readable non-transitory storage media of claim 15, wherein generating the ballast surface mesh for the particular railroad track segment comprises:
determining a plurality of ballast profiles that correspond to the particular railroad track segment;
aligning the determined plurality of ballast profiles in order along the particular railroad track segment; and
generating the ballast surface mesh based on an outline of the aligned plurality of ballast profiles.

18. The one or more computer-readable non-transitory storage media of claim 15, wherein segmenting the railroad track into the plurality of railroad track segments comprises:
determining a plurality of railroad track obstructions of the railroad track;
computing an obstruction beginning point and an obstruction ending point for each of the plurality of railroad track obstructions;
accessing a predetermined length for the plurality of railroad track segments; and
calculating a segment beginning point and a segment ending point for each of the plurality of railroad track segments using the predetermined length and one or more of the obstruction beginning points and the obstruction ending points of the plurality of railroad track obstructions.

19. The one or more computer-readable non-transitory storage media of claim 15, wherein determining the ballast volume for the particular railroad track segment comprises:
dividing the ballast surface mesh into a plurality of mesh polygons;
for each mesh polygon:
compute an average height of actual ballast using the LiDAR point cloud data;
generate a plane using the computed average height of actual ballast;
generate a voxel using the mesh polygon and the generated plane;
compute a segment ballast volume by calculating a volume of the generated voxel; and
adding all of the computed segment ballast volumes for all of the mesh polygons to compute the ballast volume for the particular railroad track segment.

20. The one or more computer-readable non-transitory storage media of claim 15, wherein the one or more LiDAR instruments are coupled to a rail vehicle, the operations further comprising capturing the LiDAR point cloud data using the one or more LiDAR instruments coupled to the rail vehicle as the rail vehicle traverses the railroad track.
